(19) United States
(12) Patent Application Publication
(10) Pub. No.: US 2014/0096815 A1
(43) Pub. Date: Apr. 10, 2014

(54) DYE-SENSITIZED SOLAR CELL

(71) Applicant: Ushio Denki Kabushiki Kaisha, Tokyo (JP)

(72) Inventor: Kazuyuki Mori, Hyogo (JP)

(73) Assignee: USHIO DENKI KABUSHIKI KAISHA, Tokyo (JP)

(21) Appl. No.: 14/041,241

(22) Filed: Sep. 30, 2013

(30) Foreign Application Priority Data
Oct. 10, 2012 (JP) 2012-225118

(51) Int. Cl. H01G 9/20

(52) U.S. Cl. CPC H01G 9/2059
USPC 136/254

(57) ABSTRACT

The invention provides a dye-sensitized solar cell including: a translucent tube-shaped vessel having sealing portions at both ends thereof, a photoelectrode, a collective electrode, and a counter electrode, the photoelectrode, the collective electrode, and the counter electrode being provided in the interior of the tube-shaped vessel; external leads electrically connected respectively to the collective electrode and the counter electrode, and electrolytic solution filled in the interior of the tube-shaped vessel, wherein remaining of air bubbles cause by evaporation of the electrolytic solution when hermetically sealing the tube-shaped vessel after having filled with the electrolytic solution is avoided, whereby preferable power generation efficiency is achieved. At least one of the external leads is formed of a metallic tube, the metallic tube is sealed by the sealing portion, and a projecting end portion of the metallic tube is hermetically sealed.

### BACKGROUND OF THE INVENTION

1. Field of the Invention

The present invention relates to a dye-sensitized solar cell configured to convert light energy to electric energy and, specifically, to a dye-sensitized solar cell in which electrolytic solution is encapsulated in a translucent tube-shaped vessel.

2. Description of the Related Art

In the related art, a solar cell configured to convert solar energy into electric energy is under positive research and development as an environment-friendly and clean energy source. Among others, a dye-sensitized solar cell attracts attention as a low-cost solar cell having high incident photon-to-current conversion efficiency, and various proposals are suggested.

An example is disclosed in Japanese Patent No. 4,840,540, in which a dye-sensitized solar cell is configured to take out electric energy by disposing a photoelectrode composed of a porous semiconductor containing electrolytic solution encapsulated in a translucent tube-shaped vessel and a dye adsorbed to the interior of the vessel and a counter electrode opposing thereto, and letting sunlight enter the photoelectrode to excite the same to allow electrons to be released.

The dye-sensitized solar cell of this type attracts attention because of having the advantages that a high-vacuum chamber or the like is not necessary for manufacture, responsibility required in terms of equipment is small, and low-cost manufacture is possible.

FIGS. 5A and 5B illustrate a schematic structure of a solar cell having the structure as described above. FIG. 5A is a drawing illustrating a process of encapsulating electrolytic solution and FIG. 5B is a drawing illustrating a state in which the encapsulating is completed.

In the drawings, the dye-sensitized solar cell includes a collective electrode 3 formed of a transparent conductive film and a photoelectrode 4 formed of a semiconductor layer having sensitized dye adsorbed thereto, the collective electrode and the photoelectrode being layered one on top of another on the inner surface of a body portion 2 of the tube-shaped vessel 1 formed of transparent glass, a coil-shaped counter electrode 5 arranged in the tube-shaped vessel 1 so as to be apart from the photoelectrode 4, and electrolytic solution 6 containing an electrolytic substance hermetically sealed in the tube-shaped vessel 1.

Both ends of the body portion 2 of the tube-shaped vessel 1 are formed with flat sealing portions 21 and 22 and hermetically sealed by heating, fusing, and pinching glass which constitutes the tube-shaped vessel 1 as pinch sealing in a lamp technology. A metal foil 31 is embedded in the interior of the sealing portion 21 on one end side, and an internal lead 11 from the counter electrode 5 and an external lead 13 projecting outward from the sealing portion 21 are connected to the metal foil 31 to achieve a conducting state.

In the same manner, a metal foil 32 is embedded in the sealing portion 22 on the other end side, and an internal lead 12 connected to the counter electrode 5 via an insulating member 15 and an external lead 14 projecting from the sealing portion 22 are connected to the metal foil 32. Then, the collective electrode 3 formed on the inner surface of the body portion 2 of the tube-shaped vessel 1 extends to the interior of the sealing portion 22, is pinch-shielded so as to cover the internal lead 12, the metal foil 32, and the external lead 14, and is electrically connected thereto.

In this configuration, in the one sealing portion 21, an electrical connection from the counter electrode 5 via the internal lead 11 and the metal foil 31 to the external lead 13 is established, while in the other sealing portion 22, an electrical connection from the photoelectrode 4 via the collective electrode 3, the internal lead 12, and the metal foil 32 to the external lead 14 is established.

In this configuration, the sealing portions 21 and 22 at the both end portions of the body portion 2 of the tube-shaped vessel 1 employ a pinch seal structure in the lamp technology as described above, and the flat sealing portions 21 and 22 having the metal foils 31 and 32 embedded therein are obtained by heating, fusing, and pinching the both end portions of the body portion 2.

A process of encapsulating the electrolytic solution 6 in the tube-shaped vessel 1 formed in this manner will be described.

As illustrated in FIG. 5A, the filling tube 23 is welded to an end area of the cylindrical-shaped body portion 2 of the tube-shaped vessel 1 where the collective electrode 3 and the photoelectrode 4 are not formed in the inner surface thereof and is communicated with the interior of the tube-shaped vessel 1.

The electrolytic solution 6 is filled into the tube-shaped vessel 1 from the filling tube 23. After the electrolytic solution 6 has filled in the tube-shaped vessel 1, the filling tube 23 is fused and sealed. With this fused and sealed tube, a sealing chip remaining portion 23a is formed on the body portion 2 of the tube-shaped vessel 1 as illustrated in FIG. 5B.

According to the related art as described above, the electrolytic solution 6 in the vicinity of the filling tube 23 is heated when sealing the filling tube 23 by heating and fusing. This heating causes a problem that the electrolytic solution 6 evaporates and remains in the tube-shaped vessel 1 as air bubbles.

The electrolytic solution 6 in the interior of the tube-shaped vessel 1 is a medium configured to transfer electrons from the counter electrode 5 to the photoelectrode 4, and has a role to reduce the sensitizing dye in the photoelectrode 4. However, when the air bubbles remain in the interior of the tube-shaped vessel 1, the remaining air bubbles are interposed on an interface between the photoelectrode 4 and the electrolytic solution 6, and hence the contact between the photoelectrode 4 and the electrolytic solution 6 becomes insufficient. Therefore, there arises a problem that the sensitizing dye carried by the photoelectrode 4 is not sufficiently reduced, and hence the power generating efficiency may be reduced.

### SUMMARY OF THE INVENTION

In view of the problems of the related art, it is an object of the invention to provide a dye-sensitized solar cell including: a photoelectrode formed of a semiconductor layer carrying a sensitizing dye, a collective electrode formed on the photoelectrode so as to come into contact therewith, and a counter electrode so as to oppose the collective electrode, the photoelectrode, the collective electrode, and the opposed electrode being provided in the interior of a tube-shaped vessel having sealing portions at both ends thereof, external leads electrically connected to the collective electrode and the counter electrode respectively, and electrolytic solution filled in the interior of the tube-shaped vessel, wherein the electrolytic solution does not evaporate when hermetically sealing an electrolytic solution filling tube after having encapsulated the electrolytic solution in the interior of the tube-shaped vessel, and no air bubble remains in the electrolytic solution after being filled in the interior of the tube-shaped vessel.

In order to solve the above-described problem, a dye-sensitized solar cell of the invention is characterized in that the external lead electrically connected to the counter electrode is formed of a metallic tube, the metallic tube is sealed by the sealing portion, and a projecting end portion of the metallic tube is hermetically sealed.

Preferably, the projecting end portion of the metallic tube is hermetically sealed by crimping.

Preferably, the metallic tube is welded to the sealing portion.

Preferably, the external lead electrically connected to the collective electrode is formed of the metallic tube, one end of the counter electrode is connected to the metallic tube via an insulating member, and the insulating member is inserted into and supported by the interior of the metallic tube.

Also preferably, the metallic tube and the tube-shaped vessel are formed of materials having a difference in coefficient of linear expansion α in a range of ±5×10⁻⁷/° C.

Preferably, the electrolytic solution contains iodine, and the metallic tube is formed of a titanium material or a material whose surface is coated titanium.

According to the dye-sensitized solar cell of the invention, since the external lead projecting from at least one of the sealing portions of the tube-shaped vessel is formed of the metallic tube, the metallic tube functions to conduct electricity to the electrode, and also functions as a filling tube for the electrolytic solution. In addition, since the projecting end portion thereof is hermetically sealed by crimping or the like, evaporation of the electrolytic solution due to heat as in the related art does not occur, and hence no air bubble exists in the electrolytic solution filled in the tube-shaped vessel. Therefore, a desirable contact state between the photoelectrode and the electrolytic solution is maintained, and the dye-sensitized solar cell having desirable power generation efficiency may be obtained.

### BRIEF DESCRIPTION OF THE DRAWINGS

FIGS. 1A and 1B are cross sectional views of a dye-sensitized solar cell of the invention;

FIGS. 2A to 2C are drawings illustrating a process of manufacturing the dye-sensitized solar cell of the invention;

FIGS. 3A to 3C are drawings illustrating a process of filling the dye-sensitized solar cell with electrolytic solution of the invention;

FIG. 4 is another example of the invention; and

FIGS. 5A and 5B are drawings illustrating a process of filling a dye-sensitized solar cell with electrolytic solution of the related art.

### DESCRIPTION OF THE PREFERRED EMBODIMENTS

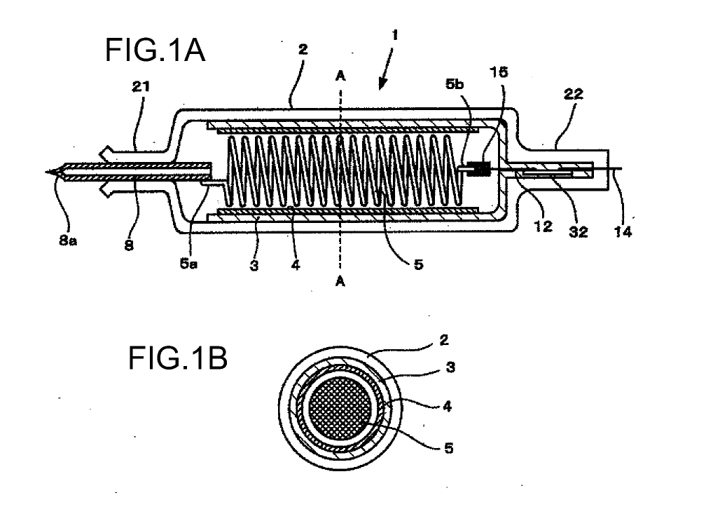

FIGS. 1A and 1B are cross-sectional views generally illustrating a dye-sensitized solar cell of the invention. FIG. 1A is a cross-sectional side view, and FIG. 1B is a cross-sectional view taken along a line A-A.

An inner surface of a body portion 2 of a tube-shaped vessel 1 is provided with a collective electrode 3 formed of a transparent conductive film and a photoelectrode 4 layered on the collective electrode 3. The collective electrode 3 is provided so as to extend from the body portion 2 to one sealing portion 22 and, on the other hand, the photoelectrode 4 exists only on the body portion 2 and does not extend to the sealing portion 22.

A coil-shaped counter electrode 5 is disposed in the body portion 2 of the tube-shaped vessel 1 so as not to abut against the photoelectrode 4.

A metallic tube 8 is sealed at one sealing portion 21 of the tube-shaped vessel 1. A shrink seal technology, which is one of lamp manufacturing technologies, is employed in this sealing, that is, the metallic tube 8 is sealed by welding of glass which constitutes the sealing portion 21, and the metallic tube 8 constitutes an external lead.

A one end portion 5a of the counter electrode 5 is connected to the metallic tube 8 to achieve an electric conduction.

The metallic tube 8 penetrates the sealing portion 21 and projects to the outside, and is hermetically sealed by crimping or the like at a projecting end portion 8a thereof.

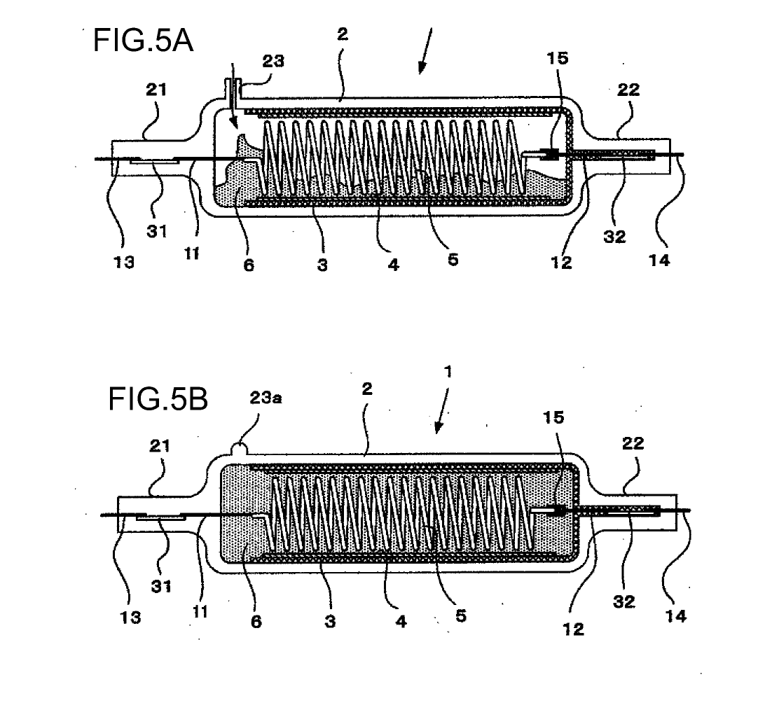

In contrast, the other sealing portion 22 has the same structure as that of the related art illustrated in FIG. 5, that is, an internal lead 12 connected to the other end portion 5b of the counter electrode 5 with an insulating member 15 interposed therebetween is connected to a metal foil 32 in the sealing portion 22, and is sealed together with the collective electrode 3. An external lead 14 is connected to the metal foil 32 and projects outward of the sealing portion 22.

In this configuration, on the one sealing portion 21 side, an electrical connection from the counter electrode 5 to the metallic tube (external lead) 8 is established, while on the other sealing portion 22 side, an electrical connection from the photoelectrode 4 via the collective electrode 3, the internal lead 12, and the metal foil 32 to the external lead 14 is established. The electric connection to the collective electrode 3 at the other sealing portion 22 requires at least the connection to the internal lead 12. However, a more stable electric connection is achieved by bringing the internal lead 12, the metal foil 32, and the external lead 14 simultaneously into electric conduction by extending the collective electrode 3 to a position of a rear end in the sealing portion 22.

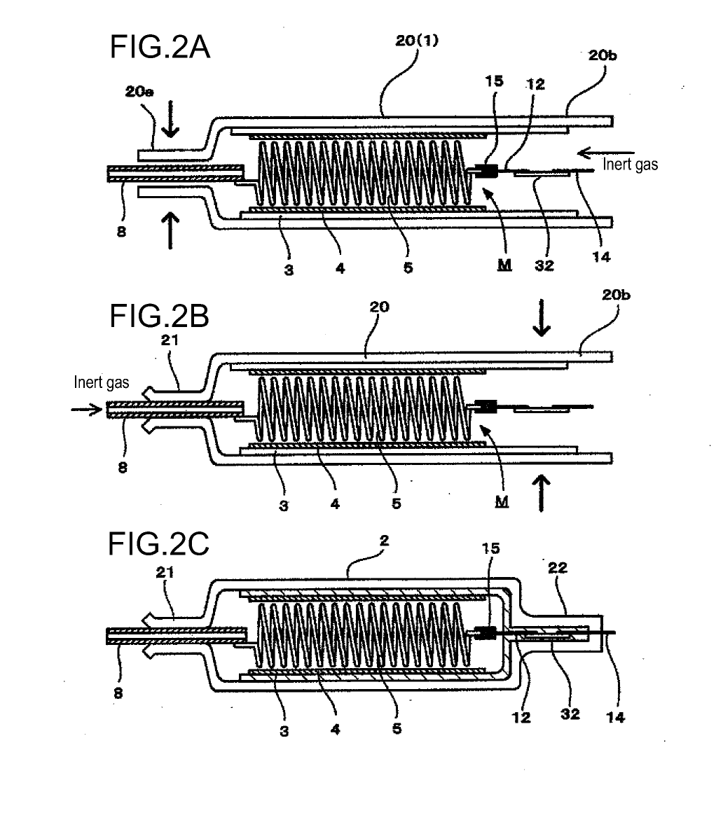

A method of manufacturing the dye-sensitized solar cell having such a structure will be roughly described with reference to FIG. 2.

As illustrated in FIG. 2A, an electrode mount M composed of the metallic tube 8, the counter electrode 5, the insulating member 15, the internal lead 12, the metal foil 32, and the external lead 14 is inserted into a glass tube 20 which constitutes the tube-shaped vessel 1 formed with the collective electrode 3 and the photoelectrode 4 on an inner surface thereof.

At one end portion of the glass tube 20, the shrink seal technology, which is one of the lamp sealing technologies, is applied to form the sealing portion 21.

In other words, an end portion 20a of the glass tube 20 on the metallic tube 8 side is fused by heat by a oxyhydrogen burner or the like while flowing inert gas such as argon from the other open end 20b of the glass tube 20 on the metal foil 32 side and is welded to an outer surface of the metallic tube 8, so that the sealing portion 21 is formed.

Subsequently, at the other end portion, the pinch seal technology, which is also one of the lamp sealing technologies, is applied to form the sealing portion 22.

In other words, as illustrated in FIG. 2B, the other end portion 20b of the glass tube 20 is fused by heat while flowing inert gas from the metallic tube 8 into the glass tube 20, and then is pinched to embed the metal foil 32 to form the sealing portion 22.

In this manner, as illustrated in FIG. 2C, the electrode mount M is integrated in the interior of the tube-shaped vessel 1, and at the sealing portion 21 on one end side thereof, the metallic tube 8 projects outward of the sealing portion in a state of being sealed, and the sealing portion 22 on the other side is formed with a structure having a shape sealed in a state in which the metal foil 32 is embedded.

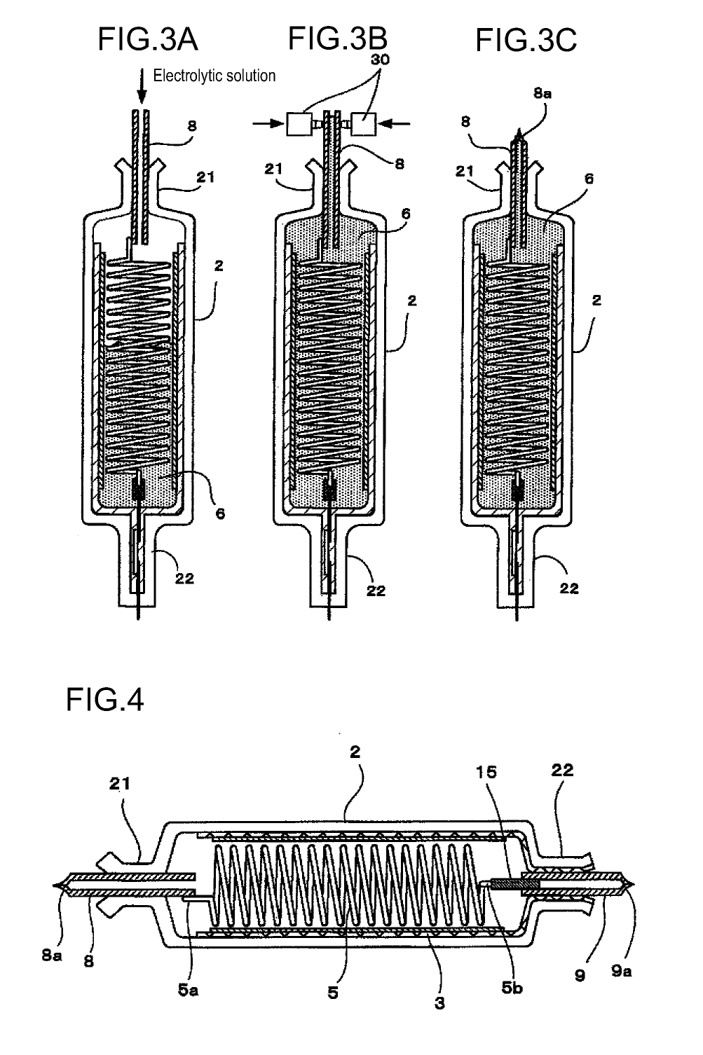

Subsequently, a process of filling the electrolytic solution and a process of sealing the tube-shaped vessel 1 will be described with reference to FIG. 3A to 3C.

As illustrated in FIG. 3A, the tube-shaped vessel 1 is provided so that the metallic tube 8 extends upward. Electrolytic solution 6 is filled into the tube-shaped vessel 1 from the metallic tube 8.

As illustrated in FIG. 3B, when the electrolytic solution 6 is filled into the tube-shaped vessel 1, an upper end of the metallic tube 8 is crimped and hermetically sealed by a pressing unit 30. At this time, since the metallic tube 8 is hermetically sealed without being heated, and hence the electrolytic solution 6 is prevented from evaporating, and remaining of air bubbles in the tube-shaped vessel 1 does not occur.

Accordingly, the dye-sensitized solar cell filled with the electrolytic solution 6 in the interior of the tube-shaped vessel 1 as illustrated in FIG. 3C is achieved.

Hermetically sealing of an end portion of the metallic tube 8 is not limited to the crimping, and may be achieved by pinching the metallic tube 8 flatly to a predetermined extent and then being welded by a pulse laser. In this case as well, thermal influence such as that in the related art in which a glass tube filled with the electrolytic solution is hermetically sealed by thermal adhesion does not occur, and evaporation of the electrolytic solution does not occur.

Although, the metallic tube 8 configured to be sealed in the glass tube-shaped vessel 1 by adhesion is disclosed in the embodiment described above. However, in this case, a combination of materials of the tube-shaped vessel 1 and the metallic tube 8 preferably have coefficients of linear expansion close to each other. If these materials have coefficients of linear expansion having a significant difference from the other, damage of the sealing portion 21 of the tube-shaped vessel 1 by being cracked may occur at the time of thermal welding.

Preferable examples of a good combination include a combination having a difference in coefficients of linear expansion α within a range of ±5×10⁻⁷/° C.

Examples of combinations of detailed materials will be listed below.

### EXAMPLE 1

Tube-Shaped Vessel: aluminosilicate glass (coefficient of linear expansion α=51×10⁻⁷/° C.)

Metallic Tube: molybdenum pipe (coefficient of linear expansion α=55×10⁻⁷/° C.)

### EXAMPLE 2

Tube-Shaped Vessel: kovar glass (coefficient of linear expansion α=55×10⁻⁷/° C.)

Metallic Tube: kovar pipe (coefficient of linear expansion α=50×10⁻⁷/° C.)

### EXAMPLE 3

Tube-Shaped Vessel: soda lime glass (coefficient of linear expansion α=90×10⁻⁷/° C.)

Metallic Tube: titanium pipe (coefficient of linear expansion α=88×10⁻⁷/° C.)

A material having a high corrosion resistant property with respect to the electrolytic solution is suitable for the metallic tube. For example, when iodine having a high reactive property with respect to metals is contained in the electrolytic solution, a titanium member or a member coated with titanium on the surface thereof is preferably used for the metallic tube.

In other words, in the example illustrated above, the metallic pipes in Example 1 and Example 2 are preferably coated with titanium on the surface thereof. For example, it is preferable to prepare a molybdenum pipe and coat the surface thereof with titanium to have a film thickness on the order of several tens of nanometer by spattering.

In the embodiments described above, the external lead connected to the counter electrode 5 is formed of the metallic tube 8. However, an external lead on the opposite side which is connected to the collective electrode 3 may be formed of a metallic tube or, alternatively, the both external leads may be formed of the metallic tubes as illustrated in FIG. 4.

In the example illustrated in FIG. 4, the metallic tube 8 is provided on the one sealing portion 21 to be electrically connected to the one end portion 5a of the counter electrode 5, and a metallic tube 9 is provided to be electrically connected to the collective electrode 3 on the other sealing portion 22 which is located on the opposite side of the sealing portion 21.

In this example, the configuration in which the other end portion 5b of the counter electrode 5 is provided with the insulating member 15, and the insulating member 15 is inserted into and supported by the interior of the metallic tube 9 is illustrated.

When this configuration is employed, the position of installation of the coil-shaped counter electrode 5 in the tube-shaped vessel 1 becomes robust, and the relative position with respect to the photoelectrode 4 is ensured.

In the both examples described above, the configuration in which the metallic tubes 8 and 9 are directly connected to the end portions of the counter electrode 5 is illustrated. However, a configuration in which the internal lead is connected to the counter electrode 5 and the internal lead is connected to the metallic tubes 8 and 9 is also applicable.

The counter electrode 5 is not limited to have a coil shape, and various forms such as a rod-shaped member, a cylindrical member, and a net-type cylindrical member may be employed.

As described above, according to the invention, there is provided the dye-sensitized solar cell including the photoelectrode, the collective electrode, and the counter electrode in the interior of the translucent tube-shaped vessel having the sealing portion on the both ends thereof, the external leads electrically connected respectively to the collective electrode and the counter electrode, and the electrolytic solution filled in the interior of the tube-shaped vessel, in which at least one of the external leads is formed of the metallic tube, the metallic tube is sealed by the sealing portion, and the projecting end portion of the metallic tube is hermetically sealed. Accordingly, the metallic tube has a function to conduct electricity to the electrode, and functions also as an electrolytic solution supply channel. In this configuration, the structure is simplified, and evaporation of the electrolytic solution by heat may be avoided by filling the tube-shaped vessel with the electrolytic solution by utilizing the metallic tube and then hermetically sealing the projecting end of the metallic tube. Therefore, no air bubble exists in the electrolytic solution in the tube-shaped vessel and hence a cause which hinders the contact between the photoelectrode and the electrolytic solution is eliminated, whereby desirable power generation efficiency may be obtained.

What is claimed is:

1. A dye-sensitized solar cell comprising:
a translucent tube-shaped vessel having sealing portions at both ends thereof;
a photoelectrode formed of a semiconductor layer carrying a sensitizing dye thereon;
a collective electrode formed in contact with the photoelectrode; and
a counter electrode opposing the collective electrode, the photoelectrode, the collective electrode, and the counter electrodes being provided in the interior of the tube-shaped vessel,
external leads electrically connected to the collective electrode and the counter electrode respectively, the external leads projecting outward from the sealing portions respectively and
electrolytic solution filled in the interior of the tube-shaped vessel, wherein
at least one of the external leads is formed of a metallic tube, the metallic tube is sealed by the sealing portion, and a projecting end portion of the metallic tube is hermetically sealed.

2. The dye-sensitized solar cell according to claim 1, wherein the projecting end portion of the metallic tube is hermetically sealed by crimping.

3. The dye-sensitized solar cell according to claim 1, wherein the metallic tube is welded to the sealing portion.

4. The dye-sensitized solar cell according to claim 1, wherein the external lead electrically connected to the collective electrode is formed of a metallic tube, one end of the counter electrode is connected to the metallic tube via an insulating member, and the insulating member is inserted into and supported by the interior of the metallic tube.

5. The dye-sensitized solar cell according to claim 1, wherein the metallic tube and the tube-shaped vessel are formed of materials having a difference in coefficient of linear expansion α in a range of ±5×10⁻⁷/° C.

6. The dye-sensitized solar cell according to claim 1, wherein the electrolytic solution contains iodine, and
the metallic tube is formed of a titanium member or a member coated with the titanium on the surface thereof.
